(19) United States
(12) Patent Application Publication
(10) Pub. No.: US 2025/0192412 A1
(43) Pub. Date: Jun. 12, 2025

(54) FILTER FOR COMMUNICATION DEVICE

(71) Applicant: KMW INC., Hwaseong-si (KR)

(72) Inventors: Nam Shin PARK, Hwaseong-si (KR); Sung Ho JANG, Yongin-si (KR); Jae Hong KIM, Yongin-si (KR); Yeon Ho SHIN, Yongin-si (KR); Jeong Moon OH, Hwaseong-si (KR)

(73) Assignee: KMW INC., Hwaseong-si (KR)

(21) Appl. No.: 19/060,640

(22) Filed: Feb. 22, 2025

Related U.S. Application Data
(63) Continuation of application No. PCT/KR2023/012584, filed on Aug. 24, 2023.

(30) Foreign Application Priority Data
Aug. 26, 2022 (KR) 10-2022-0107874
Aug. 23, 2023 (KR) 10-2023-0110842

(51) Int. Cl. H01P 1/207

(52) U.S. Cl. CPC H01P 1/207

(57) ABSTRACT

Disclosure herein may be a filter for communication devices. The filter may include a base plate that is made of a conductive material, manufactured in an unfolded state and configured to be foldable such that, upon folding, a cavity is formed inside while simultaneously positioning a plurality of resonators to protrude by a set length in a thickness direction or a width direction in the cavity. The plurality of resonators may each include, at a distal end portion thereof, a resonance characteristic end that integrally connects leading ends of a pair of remaining portions extending in a thickness direction in the cavity. The aforementioned configuration provides advantages of facilitating a slim product design, reducing insertion loss, and enhancing resonance characteristics.

### TECHNICAL FIELD

The present disclosure relates to a filter for communication devices and, more particularly, to a filter for communication devices that is easy to manufacture, facilitates securing of a usable area of a main board (or power amplifier (PA) board), and prevents an increase in the size of an entire antenna device in a thickness direction.

### BACKGROUND ART

Radio frequency devices (including all “communication devices”), such as radio frequency filters, are typically configured with a connected structure of a plurality of Such resonators are circuit elements that resonators. resonate at specific frequencies through a combination of an inductor (L) and a capacitor (C) in terms of equivalent electronic circuits. Each resonator has a structure in which a dielectric resonance element (DR) or a metallic resonance element is installed in a cavity, such as a metallic cylindrical or rectangular parallelopiped cavity enclosed by conductors. Accordingly, each resonator allows only an electromagnetic field of a unique frequency corresponding to a processing frequency band to exist within the associated cavity, thereby enabling high-frequency resonance.

Typically, the resonator has a multi-stage structure in which a plurality of cavities are used to form a plurality of resonant stages, and the plurality of resonant stages are sequentially connected.

An example of a radio frequency filter having a multi-cavity structure may include the invention disclosed in Korean Patent Application Laid-Open No. 10-2004-0100084 (Title: “Radio frequency filter,” Publication Date: Dec. 2, 2004), which was previously filed by the present applicant.

However, conventional radio frequency filters are configured such that each resonator extends in a thickness direction within a cavity, and a portion of a filter tuning cover, which covers the cavity to achieve desired band-pass characteristics, is deformed through a punching process to tune the distance to the resonator, resulting in a significant limitation in reducing the size of the completed filter in the thickness direction.

Furthermore, conventional radio frequency filters require installation of additional conductive components to implement inductive coupling or capacitive coupling as part of enhancing skirt characteristics between adjacent resonators or spaced-apart resonators within a plurality of cavities, resulting in a significant increase in the weight of the completed filter. Recently, in antenna devices utilizing massive multiple input multiple output (MMO) technology, research has been conducted to minimize the thickness of internal components, such as filters, to achieve a slimmer overall product design. Among the most commonly used filter types for the foregoing purpose, a dielectric ceramic filter is a representative example.

However, dielectric ceramic filters, due to the characteristics of the material thereof, are configured to be directly coupled in close contact with one surface of a main board (or PA board) stacked inside an antenna housing, thereby inherently limiting the double-sided use of a printed circuit board (PCB).

### DISCLOSURE

### Technical Problem

The present disclosure has been made to solve the technical problem, and an object of the present disclosure is to provide a filter for communication devices that can eliminate conventional joining processes for forming a cavity and providing structures such as resonators within the cavity, thereby reducing insertion loss caused by coupling of two physical structures.

Furthermore, another object of the present invention is to provide a filter for communication devices, in which resonance characteristic ends of a plurality of resonators provided in a cavity can be easily manufactured using a folding method.

The technical objects of the present disclosure are not limited to the above-stated objects, and those skilled in the art will clearly understand other not mentioned objects from the following description.

### Technical Solution

A filter for communication devices according to an embodiment of the present disclosure may include a base plate made of a conductive material, and manufactured in an unfolded state, the base plate being configured to be foldable such that, upon folding, a cavity is formed inside while simultaneously positioning a plurality of resonators to protrude by a set length in a thickness direction or a width direction in the cavity. The plurality of resonators each may include, at a distal end portion thereof, a resonance characteristic end that integrally connects leading ends of a pair of remaining portions extending in a thickness direction in the cavity.

Here, at least one of the plurality of resonators may be connected with an input terminal pin that is provided as a separate element and connected to an input port of a main board so that a signal transmitted from the input port is received. At least one other of the plurality of resonators may be connected with an output terminal pin that is provided as a separate element and connected to an output port of the main board so that a signal is transmitted to the output port and then output.

Furthermore, the plurality of resonators may each include a pair of resonance bars corresponding to the pair of remaining portions, and the resonance characteristic end connecting the leading ends of the pair of resonance bars. The pair of resonance bars may be formed such that the respective leading ends thereof become increasingly spaced apart in the thickness direction of the cavity.

Furthermore, the plurality of resonators each may include a pair of resonance bars corresponding to the pair of remaining portions, and the resonance characteristic end connecting the leading ends of the pair of resonance bars. The pair of resonance bars may be formed such that the respective leading ends thereof are spaced apart in parallel in the thickness direction of the cavity.

In addition, the plurality of resonators each may include a pair of resonance bars corresponding to the pair of remaining portions, and the resonance characteristic end connecting the leading ends of the pair of resonance bars. The resonance characteristic end of each of the plurality of resonators may be formed with a width equal to or greater than a width of the leading ends of at least the pair of resonance bars.

Additionally, the plurality of resonators may each include a pair of resonance bars corresponding to the pair of remaining portions, and the resonance characteristic end connecting the leading ends of the pair of resonance bars. The pair of resonance bars may each formed such that a base portion thereof corresponding to a bottom surface of the cavity and the leading end thereof have a largest width, while an intermediate portion thereof has a smallest width.

Furthermore, the base plate may be made of either a conductive material or a non-conductive material. In case that the base plate is made of the non-conductive material, a conductive material may be formed as a coating layer by plating at least on an interior corresponding to the cavity.

Furthermore, the cavity may be filled with air having a dielectric constant of 1.

In addition, the base plate, after folding, may include a body bottom forming panel that forms a bottom surface of the cavity, a first-side thickness forming panel and a second-side thickness forming panel that increase a size of the cavity in the thickness direction, and a body top forming panel provided in a shape covering a top of the cavity.

Furthermore, the body bottom forming panel may include a first-side body bottom forming panel that forms a first-side bottom surface of the cavity, and a second-side body bottom forming panel that forms a second-side bottom surface of the cavity. The first-side body bottom forming panel and the second-side body bottom forming panel may form a complete bottom surface of the cavity after folding, except for areas where the resonators are formed.

In addition, the base plate, after folding, may further include a first-side shielding panel and a second-side shielding panel that shield a first longitudinal end and a second longitudinal end of the cavity.

Additionally, the plurality of resonators may be formed on the first-side body bottom forming panel and the second-side body bottom forming panel.

### Advantageous Effects

According to a filter for communication devices of the present disclosure, since the filter is configured to allow the construction of structures in a cavity through a simple folding process without using a conventional joining method (welding or brazing), it is possible to reduce insertion loss caused by the application of the joining method, thereby improving communication reliability.

Furthermore, the present disclosure allows the formation of the cavity using a thin base plate of 3 t or less, thereby reducing a thickness direction size of an entire product of an antenna device and enhancing the effects of weight reduction and slimming of the product.

### DESCRIPTION OF DRAWINGS

FIG. 1 is a perspective view illustrating a filter for communication devices according to a first embodiment of the present disclosure,

FIG. 2 is an internal perspective view of FIG. 1,

FIG. 3 is a perspective view illustrating an unfolded state of a base plate among components of FIG. 1,

FIG. 4 is a plan view of FIG. 3,

FIG. 5 is an exploded perspective view illustrating an embodiment in which an input terminal pin and an output terminal pin among the components of FIG. 1 are provided as separate elements,

FIG. 6 shows cutaway perspective views (a and b) taken along line A-A,

FIG. 7 is a cross-sectional view and a partially enlarged plan view illustrating a structure for fixing the input terminal pin and the output terminal pin among the components of FIG. 1,

FIG. 8 is a perspective view illustrating a first implementation of a plurality of resonators among the components of FIG. 1,

FIGS. 9a and 9b are perspective views illustrating a filter for communication devices according to a second embodiment of the present disclosure,

FIGS. 10a and 10b are internal perspective views of FIGS. 9a and 9b.

FIG. 11 is a plan view of a base plate among components of FIG. 9a,

FIG. 12 is an exploded perspective view illustrating an embodiment in which an input terminal pin and an output terminal pin among the components of FIG. 9a are provided as separate elements,

FIG. 13 is a cutaway perspective view of a state in which a portion of a side plate forming part among the components of FIG. 9a is removed,

FIG. 14 shows perspective views of various implementations of a plurality of resonators among the components of FIG. 9a,

FIGS. 15a and 15b are perspective views illustrating a filter for communication devices according to a third embodiment of the present disclosure,

FIGS. 16a and 16b are internal perspective views of FIGS. 15a and 15b,

FIG. 17 is a plan view of a base plate among components of FIG. 15a,

FIG. 18 is an exploded perspective view illustrating an embodiment in which an input terminal pin and an output terminal pin among the components of FIG. 15a are provided as separate elements, and

FIG. 19 is a cutaway perspective view of a state in which a portion of a top plate forming part among the components of FIG. 15a is removed.

### DESCRIPTION OF THE REFERENCE NUMERALS

100: First embodiment 105: Base plate
110: Body bottom forming panel 120: First-side thickness forming panel
130: Second-side thickness forming panel 140: Notch forming panel
150: Body top forming panel 160: Resonator panel
170: Resonators 2100: Second embodiment
2110A: First-side body bottom forming panel
2110B: Second-side body bottom forming panel
2120: First-side thickness forming panel 2130: Second-side thickness forming panel
2150: Body top forming panel 2170: Resonators
2180A: First-side shielding panel 2180B: Second-side shielding panel
2190: Partition panel 2200: Third embodiment
2210A: First-side body bottom forming panel
2210B: Second-side body bottom forming panel
2220: First-side thickness forming panel 2230: Second-side thickness forming panel
2250: Body top forming panel 2270: Resonators
2280A: First-side shielding panel 2280B-1: First second-side shielding panel
2280B-2: Second second-side shielding panel

### BEST MODE

Hereinafter, a filter for communication devices according to embodiments of the present disclosure will be described in detail with reference to the attached drawings.

In adding reference numerals to elements in each drawing, the same elements will be designated by the same reference numerals, if possible, although they are shown in different drawings. Furthermore, in the following description of the disclosure, a detailed description of known functions and configurations incorporated herein will be omitted when it is determined that the description may make the subject matter of the disclosure rather unclear.

The terms “first”, “second”, “A”, “B”, “(a)”, “(b)”, etc. may be used herein to describe various elements of the embodiments of the present disclosure. These terms are only used to distinguish each element from another element, and do not limit the characteristics, turns, or sequences of the corresponding elements. Unless otherwise defined, all terms including technical and scientific terms used herein have the same meaning as commonly understood by one of ordinary skill in the art to which the present disclosure belongs. It will be further understood that terms commonly used and defined in standard dictionaries should be interpreted as having a meaning that is consistent with their meaning in the context of this specification and the relevant art and will not be interpreted in an idealized or overly formal sense unless expressly so defined herein.

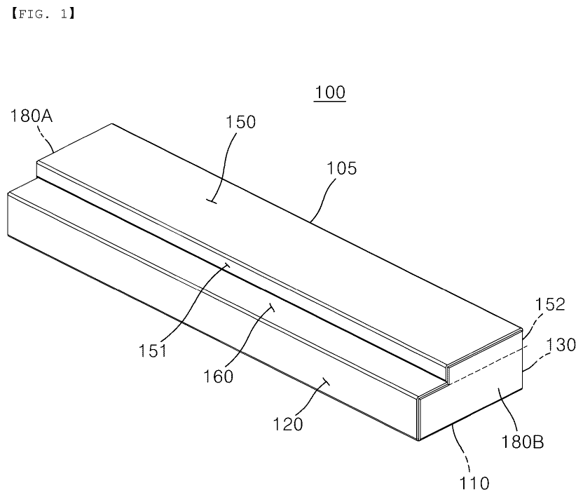

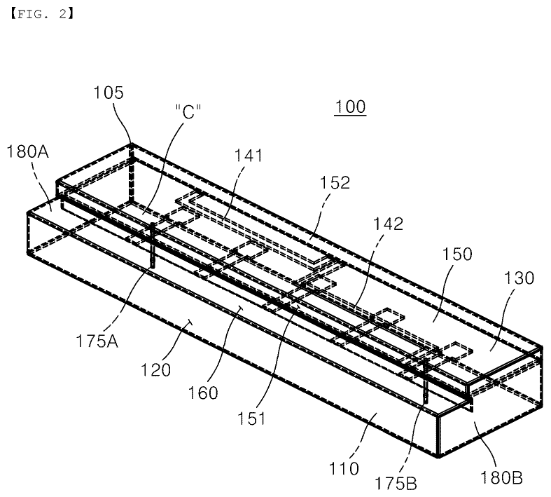

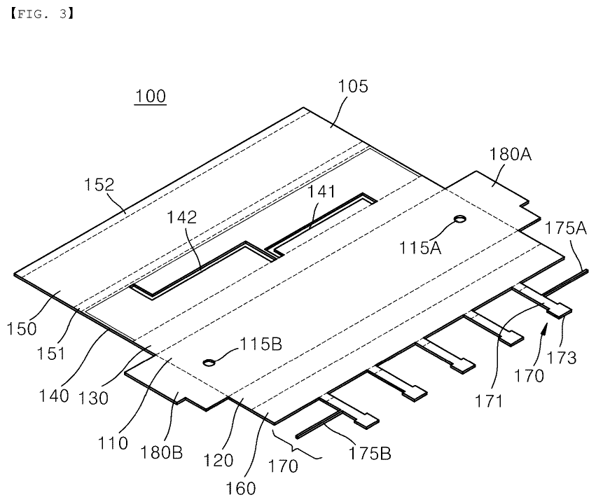

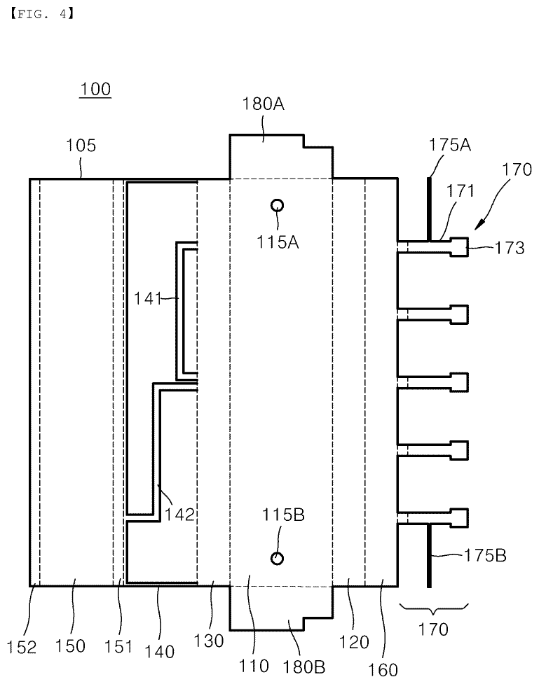

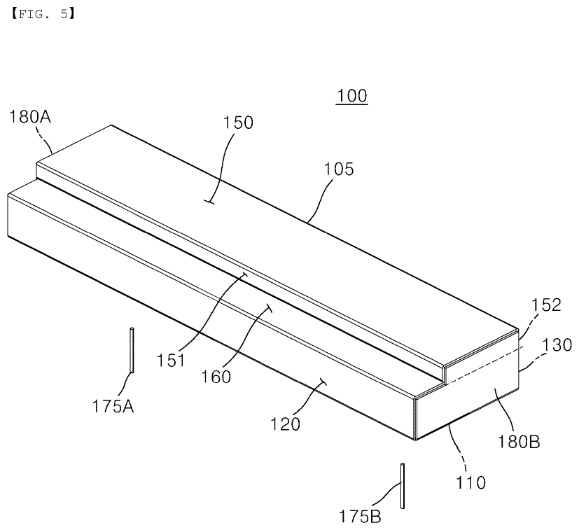

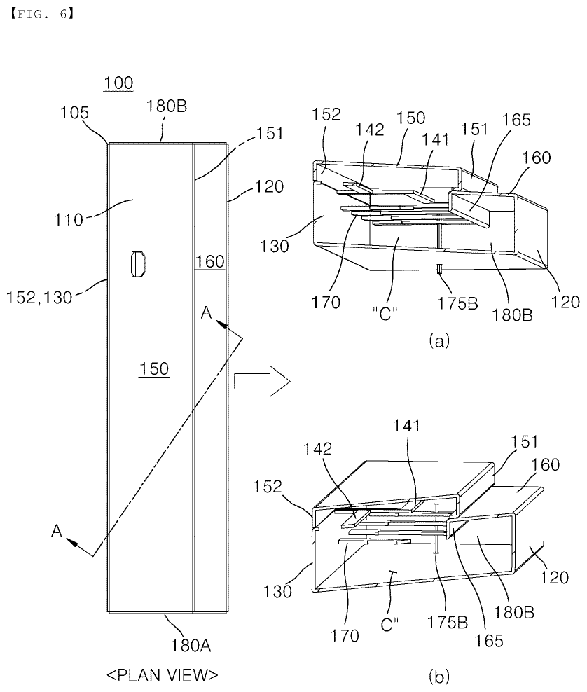

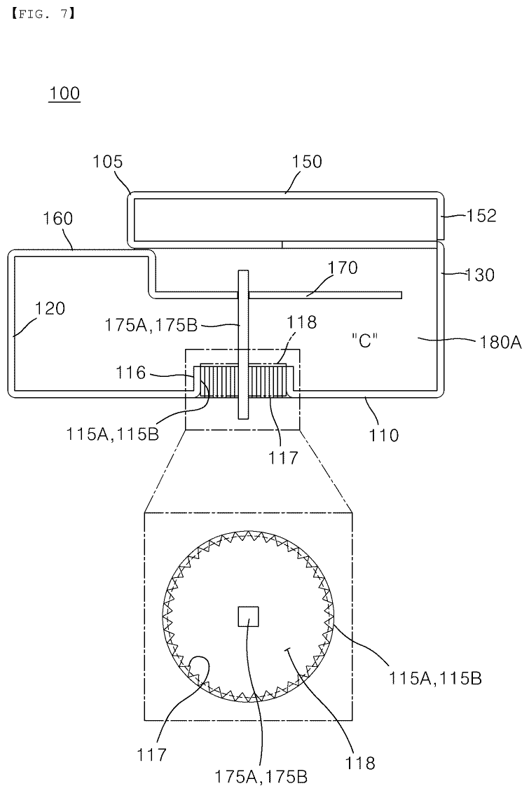

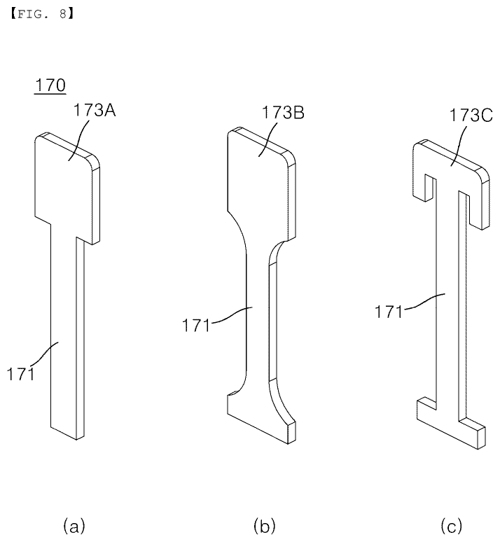

FIG. 1 is a perspective view illustrating a filter for communication devices according to a first embodiment of the present disclosure. FIG. 2 is an internal perspective view of FIG. 1. FIG. 3 is a perspective view illustrating an unfolded state of a base plate among components of FIG. 1. FIG. 4 is a plan view of FIG. 3. FIG. 5 is an exploded perspective view illustrating an embodiment in which an input terminal pin and an output terminal pin among the components of FIG. 1 are provided as separate elements. FIG. 6 shows cutaway perspective views (a and b) taken along line A-A. FIG. 7 is a cross-sectional view and a partially enlarged plan view illustrating a structure for fixing the input terminal pin and the output terminal pin among the components of FIG. 1. FIG. 8 is a perspective view illustrating a first implementation of a plurality of resonators the components of FIG. 1.

Generally, filters in the field of antenna technology perform a role of filtering signals that need to be input or output to allow only signals within a specific frequency band to pass during signal transmission and reception processes, thereby ensuring that only the signals desired by a consumer (user) are obtained as a final result.

For such signal filtering, a cavity filter, as indicated by the name thereof, forms a cavity as a predetermined signal filtering section between an input port, where signals are input, and an output port, where signals are output, thereby enabling acquisition of specific frequency band signal values within a range desired by the consumer through a frequency tuning process using the cavity.

However, to date, in the industry manufacturing antenna devices, the only disclosed method for manufacturing a cavity filter is a method that includes forming the aforementioned cavity by processing an interior of a filter body made of a ceramic material or a material with higher rigidity, and then separately manufacturing essential components for frequency filtering, such as a plurality of resonators, and fixing the components inside the cavity.

However, the filter for communication devices according to embodiments of the present disclosure departs from the aforementioned manufacturing method and discloses a groundbreaking technical feature that enables the construction of a structure within the cavity without using a separate bonding process by processing a single and flat base plate in the form of sheet metal to a thickness not exceeding a predetermined value, and performing a folding process. Hereinafter, specific technical features will be described sequentially in the order of the embodiments.

A filter 100 for communication devices according to the first embodiment of the present disclosure is manufactured in an unfolded state and includes a conductive base plate 105 configured to be foldable so that when folded, the base plate 105 forms a cavity C therein and allows a plurality of resonators 170, which protrude a predetermined length in the thickness direction or width direction, to be positioned inside the cavity C.

The base plate 105 is preferably made of a conductive material; however, it should be noted in advance that the base plate 105 may also be made of a non-conductive material for ease of manufacturing, and to enable the cavity C to perform the function thereof, a conductive material may subsequently form a coating layer by plating on both the interior and exterior, including the cavity C, or at least on the interior corresponding to the cavity C.

However, the base plate 105 is preferably made of a deformable material that can be suitably processed, as the base plate 105 is required to continuously maintain the shape thereof after being deformed through the folding process, as described below, unless subjected to an external force.

Here, the cavity C is a dielectric-filled space in which a dielectric material having a predetermined dielectric constant is filled, referring to a space that remains empty to allow the dielectric material to be charged. Since air is also a type of dielectric with a dielectric constant of 1, it should be noted in advance that when atmospheric-pressure air is adopted as the dielectric material, a separate dielectric filling process is not required.

In the filter 100 for communication devices according to the first embodiment of the present disclosure, the base plate 105 serves to form the cavity C, which functions as a dielectric-filled space.

Here, as referenced in FIGS. 3 and 4, the base plate 105 may include: a body bottom forming panel 110, which forms a bottom surface of the cavity C after folding; a first-side thickness forming panel 120 and a second-side thickness forming panel 130, which extend in a plane from a first widthwise end and a second widthwise end of the body bottom forming panel 110 such that the width of the body bottom forming panel 110 increases, thereby increasing the size of the cavity C in the thickness direction; a resonator panel 160, which extends from a distal end of either the first-side thickness forming panel 120 or the second-side thickness forming panel 130 and is provided with a plurality of resonators 170 that protrude into the cavity C at a position corresponding to space above the body bottom forming panel 110; and a body top forming panel 150, which extends from a distal end of a remaining one of the first-side thickness forming panel 120 and the second-side thickness forming panel 130 and is provided in a shape covering the top of the cavity C to face the body bottom forming panel 110.

Furthermore, a first-side shielding panel 180A and a second-side shielding panel 180B, which shield an open first longitudinal end and an open second longitudinal end of the cavity C, may integrally extend from the first longitudinal end and the second longitudinal end of the body bottom forming panel 110.

Here, the first-side shielding panel 180A and the second-side shielding panel 180B are described as being integrally formed with the body bottom forming panel 110, but it is apparent that, depending on the embodiment, the first-side shielding panel 180A and the second-side shielding panel 180B may also be symmetrically and integrally provided on an adjacent panel, such as the body top forming panel 150. Furthermore, the first-side shielding panel 180A and the second-side shielding panel 180B may be integrally formed with adjacent panels to be separately provided in two components, respectively, and may be configured to completely shield the open portions of the cavity C through the folding operation.

The body bottom forming panel 110 may be provided with an input port installation portion 115A and an output port installation portion 115B, which are respectively formed to vertically penetrate the first longitudinal end and the second longitudinal end. An input terminal pin 175A, which will be described later, may be installed through the input port installation portion 115A, and an output terminal pin 175B, which will be described later, may be installed through the output port installation portion 115B.

Particularly, as referenced in FIG. 7, the input port installation portion 115A and the output port installation portion 115B are formed as circular holes larger than the horizontal cross-sectional area of the input terminal pin 175A or the output terminal pin 175B. A portion of an edge of each of the holes may protrude a predetermined length inward into the cavity C to form a boss portion 116.

Here, a Teflon component 118 is provided on an outer surface of the input terminal pin 175A or the output terminal pin 175B for impedance matching. A fixing protrusion portion 117 having a stud or serration-like projection shape is integrally formed, to ensure stable installation of the Teflon component 118, on an inner circumferential surface of the hole in each of the input port installation portion 115A and the output port installation portion 115B, where the boss portion 116 is provided. The Teflon component 118 is press-fitted into and securely fixed to the hole, thereby minimizing insertion loss.

In addition, as referenced in FIGS. 3 and 4, the base plate 105 may further include a notch forming panel 140, which is provided between the body top forming panel 150, which connects the first-side thickness forming panel 120 and the second-side thickness forming panel 130, and the resonators 170 of the resonator panel 160. The notch forming panel 140 is arranged to extend in a horizontal direction (or thickness direction) in the cavity C.

The notch forming panel 140 is provided in the form of a frame that is penetrated in the vertical direction, having a shape corresponding to a peripheral shape of the cavity C, and may be formed with an L-notch portion 141 and a C-notch portion 142, each having a specific shape, at a first inner end and a second inner end in the width direction.

The L-notch portion 141 and the C-notch portion 142 are not necessarily required to be provided on the notch forming panel 140, and it is apparent that the L-notch portion 141 and the C-notch portion 142 may be integrally formed on the body top forming panel 150, as long as they can be subsequently modified within a permissible range inside the cavity C by an operator who performs frequency tuning later.

As referenced in FIGS. 3 and 4, in the case where the notch forming panel 140 is provided together with the body top forming panel 150, a first-side spacing panel 151 and a second-side spacing panel 152, which space the notch forming panel 140 and the body top forming panel 150 apart from each other in the thickness direction within the cavity C, may be further integrally provided on the base plate 105.

Here, a lower end of the second-side spacing panel 152 may be welded to an upper end of the second-side thickness forming panel 130, which is a starting portion (first end) where the notch forming panel 140 is formed, after the folding of the body top forming panel 150 is completed.

Furthermore, an ending portion (second end) of the notch forming panel 140, which corresponds to a lower end of the first-side spacing panel 151, may be welded to an upper surface of a portion of the resonator panel 160 that overlaps the ending portion in the thickness direction, after the folding of the resonator panel 160 is completed.

The body top forming panel 150 may be integrally formed, by cutting, with frequency tuning bars (not shown), which perform fine frequency tuning by adjusting a separation distance from the plurality of resonators 170 that are arranged to form a single layer in the thickness direction inside the cavity C, and a plurality of coupling adjustment bars (not shown), which are each deformed directly downward between the plurality of resonators 170.

It is apparent that the body top forming panel 150 may be formed with a tool insertion hole (not shown) penetrating vertically to allow the aforementioned L-notch portion 141 and C-notch portion 142 to be deformed using a predetermined tool.

As referenced in FIGS. 2 to 7, for example, on the assumption that the cavity C, generated by folding each portion of the base plate 105, is formed as a slim rectangular parallelepiped that is relatively long in a longitudinal small vertical thickness direction and has a markedly compared to front-rear and width directions, the plurality of resonators 170 may be provided to form a single uniform layer in the thickness direction of the cavity C.

The L-notch portion 141 and the C-notch portion 142 provided on the notch forming panel 140 may also form a single uniform layer in the thickness direction of the cavity C but may be provided to form a distinct single layer separate from the aforementioned plurality of resonators 170.

Since the thickness of each of the single layer formed by the plurality of resonators 170 and the single layer formed by the L-notch portion 141 and the C-notch portion 142 corresponds to none other than the thickness of the base plate 105 and the single layer is provided with a markedly slim thickness, it provides the advantage of enabling a slim design as desired by the designer without increasing the overall size, including the thickness of the entire product.

As referenced in FIG. 8, the plurality of resonators 170 may each include, at a distal end portion thereof, a resonance characteristic end 173 that is flat to form the same layer as a remaining portion within the cavity C and has a wider width than the remaining portion. Hereinafter, for convenience of explanation, among the structural portions of each of the plurality of resonators 170, a body portion that integrally extends from the base plate 105 and is connected at the distal end portion thereof to the resonance characteristic end 173 is referred to as a resonance bar 171.

At least one of the plurality of resonators 170 may be integrally formed with the input terminal pin 175A that is connected to an input port (not shown) so that a signal transmitted from the input port is input to the at least one resonator 170. At least one other of the plurality of resonators 170 may be integrally formed with an output terminal pin 175B that is connected to an output port (not shown) so that a signal is transmitted to the output port and then output.

As referenced in FIG. 8a, the resonance characteristic end 173 of each of the plurality of resonators 170 may integrally extend to be angled from the leading end of the remaining portion (resonance bar 171).

Alternatively, as referenced in FIG. 8b, the resonance characteristic end 173 of each of the plurality of resonators 170 may integrally extend to be rounded from the leading end of the remaining portion (resonance bar 171).

As a final example, as referenced in FIG. 8c, the resonance characteristic end 173 of each of the plurality of resonators 170 may integrally extend in a ‘U’ shape that surrounds the leading end of the remaining portion (resonance bar 171).

A brief explanation of a method for manufacturing the filter for communication devices according to the first embodiment of the present invention, which is configured as described above, is as follows.

First, after preparing the base plate 105 made of a conductive or non-conductive material (a base plate preparation process), the base plate 105 may be transferred to a press mold and subjected to press sheet metal processing in a pre-designed shape (a press sheet metal processing process).

In this case, as described above, the base plate 105 is preferably designed as a sheet metal structure to form the cavity C, which is shielded from the outside by the body bottom forming panel 110, the first-side thickness forming panel 120, the second-side thickness forming panel 130, the first-side shielding panel 180A, the second-side shielding panel 180B, the body top forming panel 150, and other panels directly connected thereto (e.g., the first-side spacing panel 151 and the second-side spacing panel 152), through a folding process described later.

After performing press sheet metal processing on the base plate 105 through the press sheet metal processing process, in the case where the base plate 105 is made of a non-conductive material, a separate conductive coating process may be additionally performed so that a conductive material forms a coating layer on the entire interior of at least the cavity C, and subsequently, a folding process may be sequentially performed to form the cavity C.

Here, the folding process includes sequentially folding the panels associated with forming the cavity C from the bottom to the top, with reference to the body bottom forming panel 110. During the folding process, the panels are folded so that the plurality of resonators 170 formed on the resonator panel 160 form the same layer (or a single layer) within the cavity C, while the L-notch portion 141 and the C-notch portion 142 formed on the notch forming panel 140 form a distinct single layer separate from the plurality of resonators 170 within the cavity C.

The embodiment of the filter for communication devices according to the present disclosure is not necessarily limited to the aforementioned first embodiment 100, as long as the cavity C is formed through a process of folding the base plate 105. Hereinafter, a filter 2100 for communication devices according to a second embodiment of the present disclosure will be described in detail.

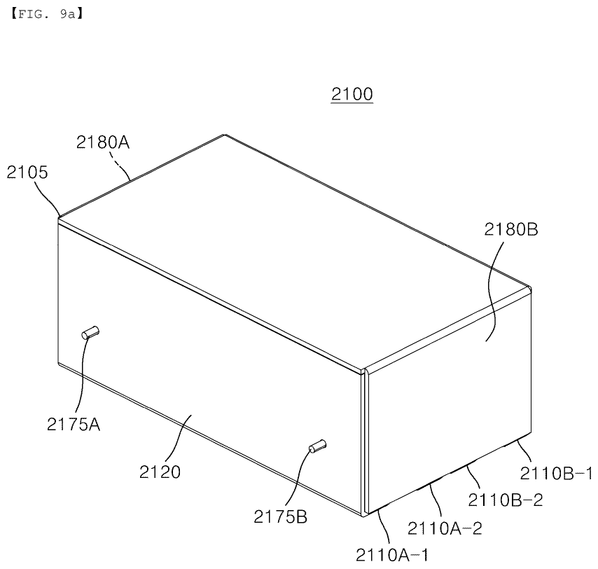

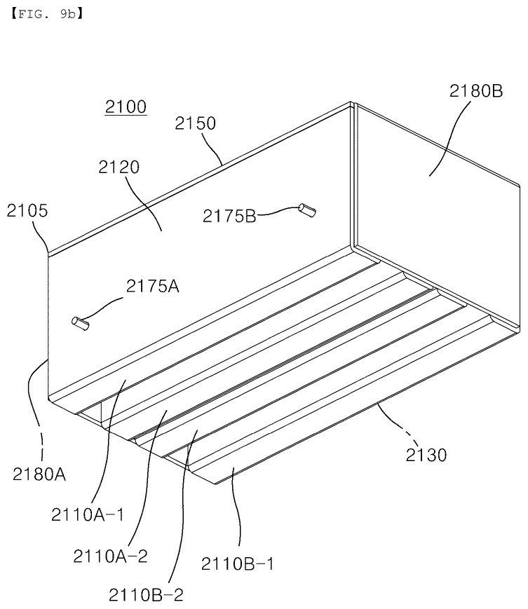

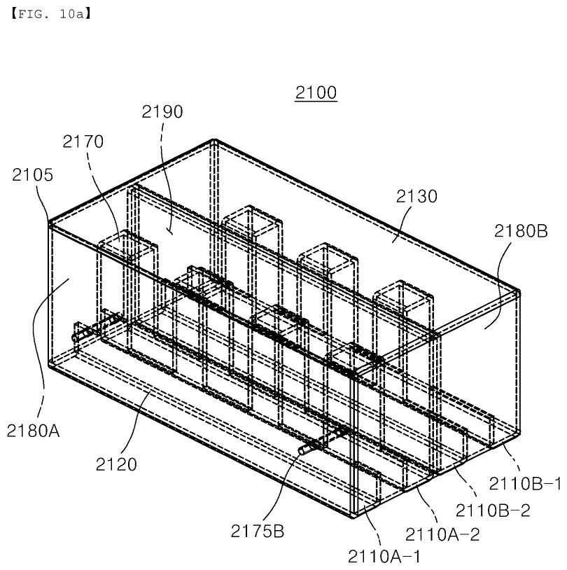

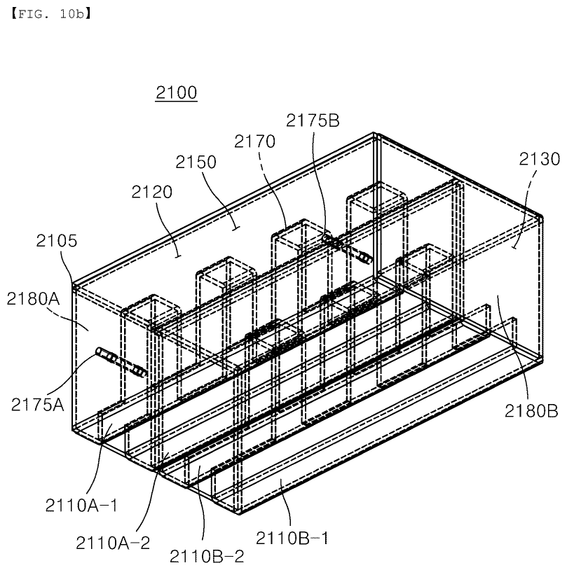

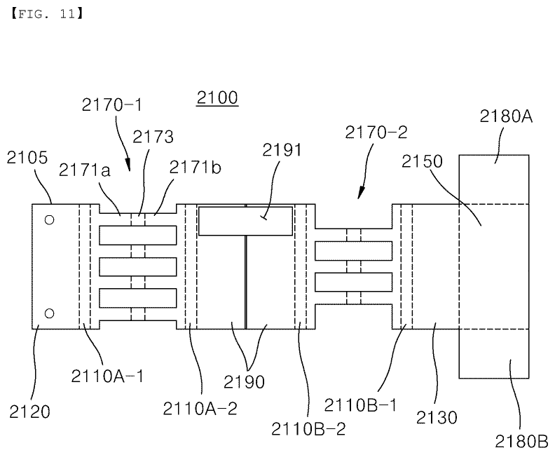

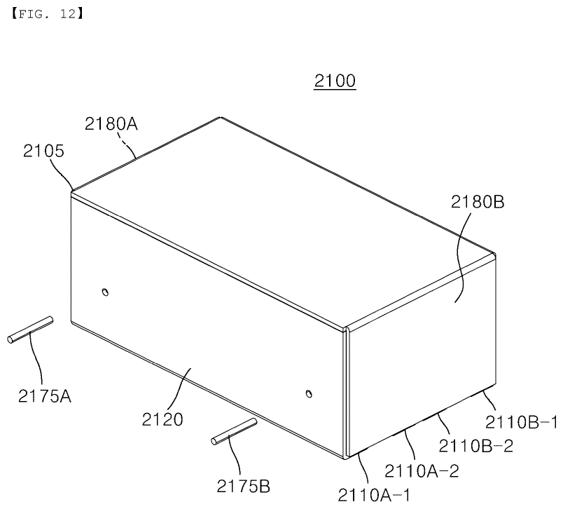

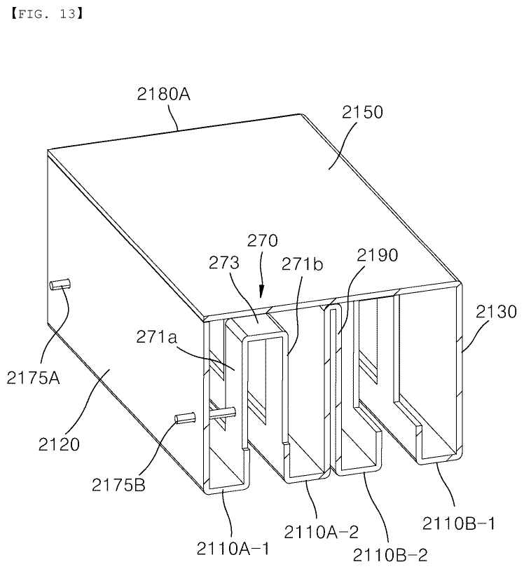

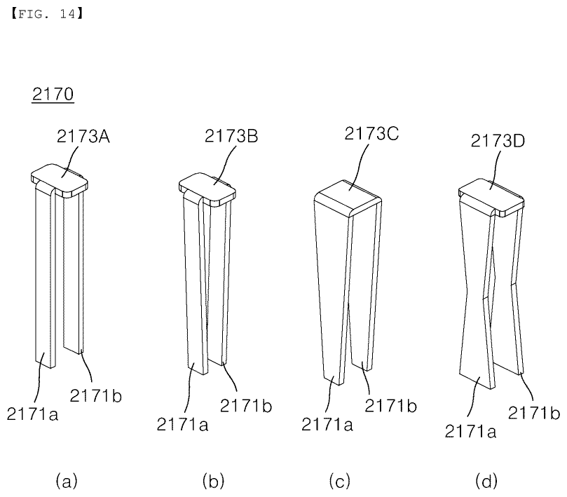

FIGS. 9a and 9b are perspective views illustrating a filter for communication devices according to a second embodiment of the present disclosure. FIGS. 10a and 10b are internal perspective views of FIGS. 9a and 9b. FIG. 11 is a plan view of a base plate among components of FIG. 9a. FIG. 12 is an exploded perspective view illustrating an embodiment in which an input terminal pin and an output terminal pin among the components of FIG. 9a are provided as separate elements. FIG. 13 is a cutaway perspective view of a state in which a portion of a side plate forming part among the components of FIG. 9a is removed. FIG. 14 shows perspective views of various implementations of a plurality of resonators among the components of FIG. 9a.

In a filter 2100 for communication devices according to the second embodiment of the present disclosure, as referenced in FIGS. 9a to 14, a base plate 2105 may include: first-side body bottom forming panels 2110A-1 and 2110A-2 and second-side body bottom forming panels 2110B-1 and 2110B-2 that form a bottom surface of a cavity C after folding, the first-side body bottom forming panels 2110A-1 and 2110A-2 forming a first-side bottom surface based on a center in a width direction, and the second-side body bottom forming panels 2110B-1 and 2110B-2 forming a second-side bottom surface based on the center in the width direction; a first-side thickness forming panel 2120 that forms a first-side sidewall of the cavity C; a second-side thickness forming panel 2130 that forms a second-side sidewall of the cavity C; a first-side shielding panel 2180A that covers an open portion on a first side of the cavity C; a second-side shielding panel 2180B that covers an open portion on a second side of the cavity C; a plurality of resonators 2170 that are formed to protrude in a thickness direction from the bottom surface of the cavity C; and a partition panel 2190 that divides the cavity C into two spaces in the width direction.

The first-side body bottom forming panels 2110A-1 and 2110A-2 may include a first first-side body bottom forming panel 2110A-1 that forms an outer bottom surface of the cavity C based on an area where some resonators 2170-1 of the plurality of resonators 2170 are positioned, and a second first-side body bottom forming panel 2110A-2 that forms an inner bottom surface of the cavity C based on the area where the resonators 2170-1 of the plurality of resonators 2170 are positioned.

The second-side body bottom forming panels 2110B-1 and 2110B-2 may include a first second-side body bottom forming panel 2110B-1 that forms an outer bottom surface of the cavity C based on an area where remaining resonators 2170-2 of the plurality of resonators 2170 are positioned, and a second second-side body bottom forming panel 2110B-2 that forms an inner bottom surface of the cavity C based on the area where the remaining resonators 2170-2 of the plurality of resonators 2170 are positioned.

In other words, the first-side body bottom forming panels 2110A-1 and 2110A-2 and the second-side body bottom forming panels 2110B-1 and 2110B-2 may form the complete bottom surface of the cavity C after folding, except for the areas where the resonators 2170 are formed.

The plurality of resonators 2170 may include first resonators 2170-1 that are provided between the first first-side body bottom forming panel 2110A-1 and the second first-side body bottom forming panel 2110A-2, and second resonators 2170-2 that are provided between the first second-side body bottom forming panel 2110B-1 and the second second-side body bottom forming panel 2110B-2.

That is, the first resonators 2170-1 connect the first first-side body bottom forming panel 2110A-1 and the second first-side body bottom forming panel 2110A-2, and are formed in a shape, protruding upward in the thickness direction from the bottom surface of the cavity C when folded. The second resonators 2170-2 connect the first second-side body bottom forming panel 2110B-1 and the second second-side body bottom forming panel 2110B-2, and are formed in a shape, protruding upward in the thickness direction from the bottom surface of the cavity C when folded. More specifically, the body bottom forming panels 2110A-1, 2110A-2, 2110B-1, and 2110B-2, which form the bottom surface of the cavity C, are divided into four panels in the width direction. Between the two first-side body bottom forming panels 2110A-1 and 2110A-2 in the width direction, the first resonators 2170-1 of the plurality of resonators 2170 may be integrally provided to form a single row in the longitudinal direction. Between the two second-side body bottom forming panels 2110B-1 and 2110B-2 in the width direction, the second resonators 2170-2 of the plurality of resonators 2170 may be integrally provided to form a single row in the longitudinal direction.

Furthermore, between the two body bottom forming panels 2110A-2 and 2110B-2, which are formed at the center among the body bottom forming panels 2110, the partition panel 2190 may be integrally formed to divide the cavity C into two spaces in the width direction, with at least one window 2191 cut out in the partition panel 2190.

The body bottom forming panels 2110A-1 and 2110B-1, which are provided at the outermost positions in the width direction among the body bottom forming panels 2110, may be integrally formed with the first-side thickness forming panel 2120 and the second-side thickness forming panel 2130 that define the thickness of the cavity C. In particular, the body top forming panel 2150, which forms the top of the cavity C, may be integrally formed on an outer side of the second-side thickness forming panel 2130. The first-side shielding panel 2180A and the second-side shielding panel 2180B may be integrally formed on the first and second longitudinal ends of the body top forming panel 2150 to shield the open portions on first and second longitudinal sides of the cavity C.

Here, the body top forming panel 2150 may be integrally formed with a plurality of tuning bars (not shown) that perform fine frequency tuning by adjusting the spacing distance from resonance characteristic ends 2173 of the plurality of resonators 2170, which are provided to protrude upward from the bottom of the cavity C, and with coupling adjustment bars (not shown), which are deformed between the respective resonators 2170 to adjust the coupling value.

As referenced in FIG. 14, the plurality of resonators 2170-1 and 2170-2, which are integrally formed between the first-side body bottom forming panels 2110A-1 and 2110A-2 and between the second-side body bottom forming panels 2110B-1 and 2110B-2, may each include a pair of resonance bars 2171 that protrude and extend upward in parallel in the cavity C from the adjacent body bottom forming panels 2110A-1 and 2110A-2 or 2110B-1 and a resonance 2110B-2, and characteristic end 2173 that perpendicularly connects upper ends of the pair of resonance bars 2171a and 2171b.

More specifically, as referenced in (a), (c), and (d) in FIG. 14, respective distal ends and respective base portions of a pair of different parts (e.g., resonance bars 2171a and 2171b) related to the resonance characteristic ends 2173A, 2173C, and 2173D of the plurality of resonators 2170 may be spaced apart to be parallel with each other regardless of the height in the thickness direction of the cavity C. Furthermore, as referenced in (b) in FIG. 14,

respective distal ends of a pair of different parts (e.g., resonance bars 2171a and 2171b) related to the resonance characteristic end 2173B of the plurality of resonators 2170 may be formed to become increasingly spaced apart from each other in the thickness direction of the cavity C from their base portions.

As referenced in (a) to (d) in FIG. 14, it is apparent that the resonance characteristic ends 2173A to 2173D of the plurality of resonators 2170 may be formed to have a width that is at least equal to (refer to (c) in FIG. 14) or greater than (refer to (a), (b), and (d) in FIG. 14) the width of the distal ends of the pair of different parts (e.g., resonance bars 2171).

In addition, as referenced in (c) in FIG. 14, the pair of resonance bars 2171a and 2171b related to the resonance characteristic end 2173C of the plurality of resonators 2170 may each be formed such that the width thereof gradually increases from the base portion toward the distal end. As referenced in (d) in FIG. 14, the pair of resonance bars 2171a and 2171b related to the resonance characteristic end 2173D of the plurality of resonators 2170 may each be formed such that the widths thereof at both the base portion and the distal end are the largest, while the width at an intermediate portion is the smallest.

Furthermore, in the filter 100 for communication devices according to the first embodiment of the present disclosure, the input terminal pin 175A and the output terminal pin 175B are each integrally formed with one of the resonators 170 and then fixedly installed by penetrating the corresponding one of the input port installation portion 115A and the output port installation portion 115B formed in the body bottom forming panel 110 during the folding process. In contrast, in the filter 2100 for communication devices according to the second embodiment of the present disclosure, an input terminal pin 2175A and an output terminal pin 2175B are provided as separate elements and fixedly installed by penetrating an input port installation portion (reference numeral not indicated) formed in the first-side thickness forming panel 2120 and an output port installation portion (reference numeral not indicated) formed in the second-side thickness forming panel 2130, respectively.

The input terminal pin 2175A may be connected to an input port formed in an unillustrated main board and to one of the plurality of resonators 2170 so that a transmitted from the input port is received. The output terminal pin 2175B may be connected to an output port formed in the unillustrated main board and to one of the plurality of resonators 2170 so that a signal is transmitted to the output port and then output.

In the filter 2100 for communication devices according to the second embodiment of the present disclosure, a folding method and sequence of the base plate 2105 follow those referenced in FIG. 11.

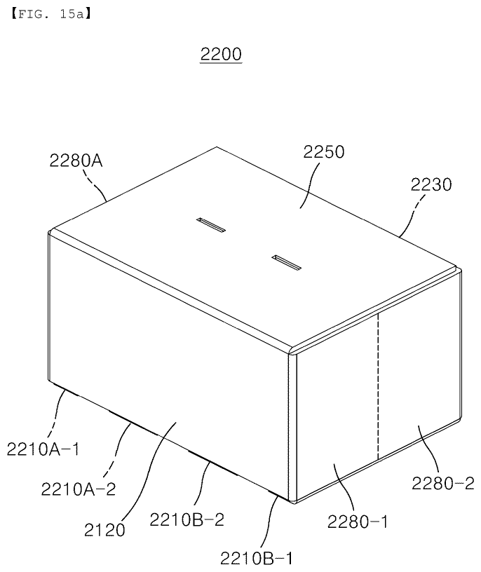

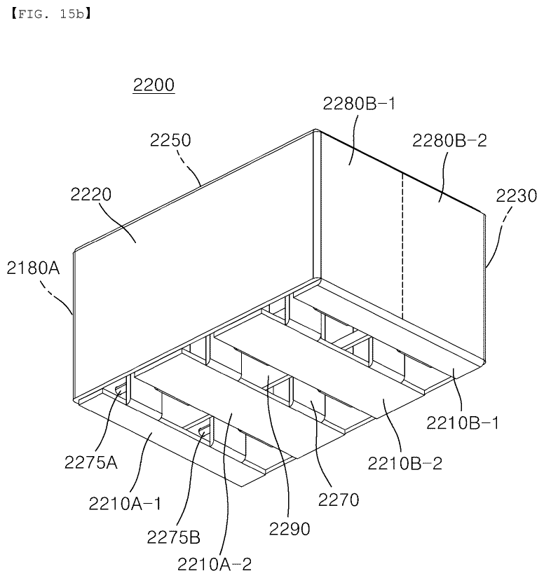

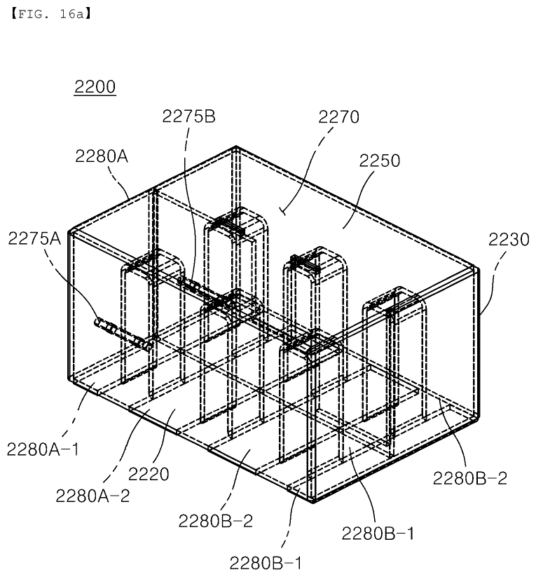

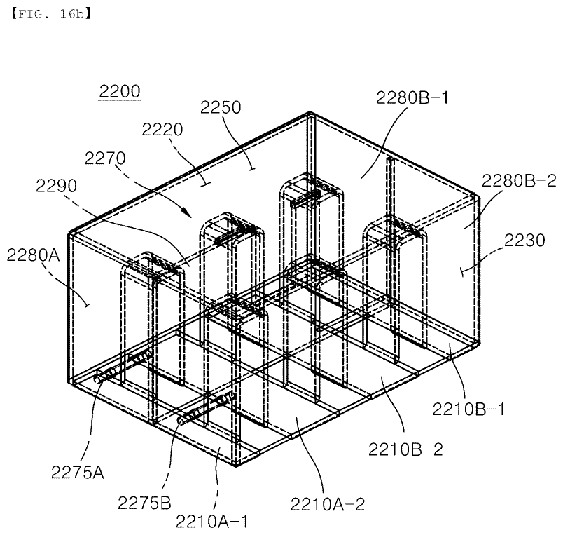

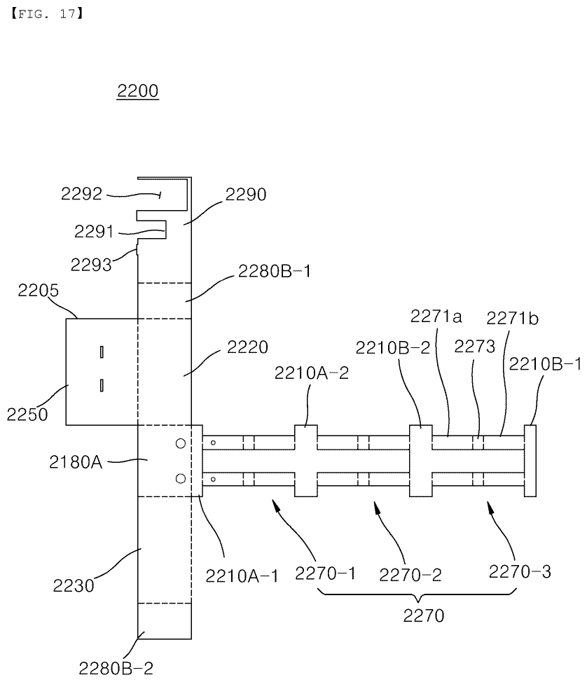

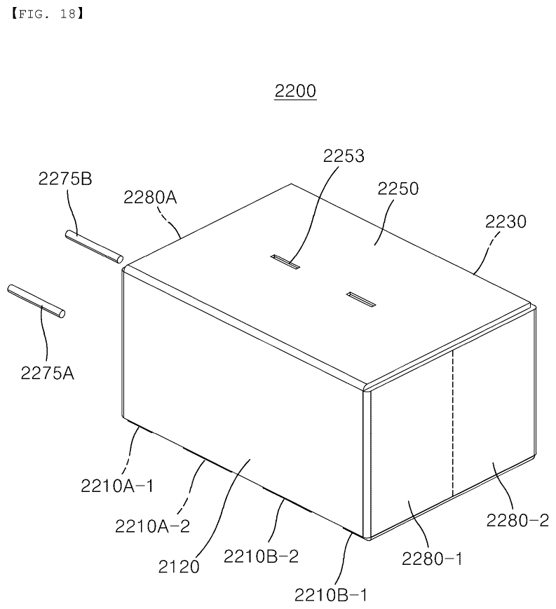

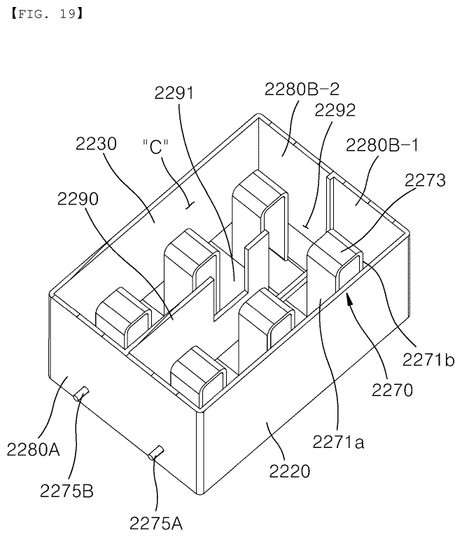

FIGS. 15a and 15b are perspective views illustrating a filter for communication devices according to a third embodiment of the present disclosure. FIGS. 16a and 16b are internal perspective views of FIGS. 15a and 15b. FIG. 17 is a plan view of a base plate among components of FIG. 15a. FIG. 18 is an exploded perspective view illustrating an embodiment in which an input terminal pin and an output terminal pin among the components of FIG. 15a are provided as separate elements. FIG. 19 is a cutaway perspective view of a state in which a portion of a top plate forming part among the components of FIG. 15a is removed.

In a filter 2200 for communication devices according to the third embodiment of the present disclosure, as referenced in FIGS. 15a to 19, a base plate 2205 may include a body bottom forming panel 2210, a first-side thickness forming panel 2220, a second-side thickness forming panel 2230, a first-side shielding panel 2280A, a second-side shielding panel 2280B, a plurality of resonators 2270, and a partition panel 2290.

More specifically, the base plate 2205 may include: first-side body bottom forming panels 2210A-1 and 2210A-2 and second-side body bottom forming panels 2210B-1 and 2210B-2 that form a bottom surface of the cavity C after folding, the first-side body bottom forming panels 2210A-1 and 2210A-2 forming a first-side bottom surface based on a center in the longitudinal direction, and the second-side body bottom forming panels 2210B-1 and 2210B-2 forming a second-side bottom surface based on the center in the longitudinal direction; a first-side thickness forming panel 2220 that forms a first-side sidewall of the cavity C; a second-side thickness forming panel 2230 that forms a second-side sidewall of the cavity C; a first-side shielding panel 2280A that covers an open portion on a first longitudinal side of the cavity C; and a second-side shielding panel 2280B that covers an open portion on a second longitudinal side of the cavity C; a plurality of resonators 2270 that are formed to protrude in a thickness direction from the bottom surface of the cavity C; and a partition panel 2290 that divides the cavity C into two spaces in a width direction.

Specifically, when the first-side body bottom forming panels 2210A-1 and 2210A-2 and the second-side body bottom forming panels 2210B-1 and 2210B-2, which form the bottom surface of the cavity C, are divided into four sections in the longitudinal direction, some resonators 2270-1 of the plurality of resonators 2270 may be integrally provided to form a single row in the width direction between two body bottom forming panels on a first longitudinal side (i.e., the first first-side body bottom forming panel 2210A-1 and the second first-side body bottom forming panel 2210A-2). Other resonators 2270-2 may be integrally provided to form a single row in the width direction between two body bottom forming panels on a longitudinal center (i.e., the second first-side body bottom forming panel 2210A-2 and the second second-side body bottom forming panel 2210B-2). Remaining resonators 2270-3 may be integrally provided to form a single row in the width direction between two body bottom forming panels on a second longitudinal side (i.e., the first second-side body bottom forming panel 2210B-1 and the second second-side body bottom forming panel 2210B-2). Therefore, a total of six resonators 2270 may be arranged in three rows of two in the width direction and in two rows of three in the longitudinal direction.

Furthermore, on an outer end of the first first-side body bottom forming panel 2210A-1, which is formed at the outermost position in the longitudinal direction among the body bottom forming panels 2210, the first-side shielding panel 2280A may be integrally formed to shield a first-side open portion of the open portions on the first and second longitudinal sides of the cavity C. The first-side thickness forming panel 2220 and the second-side thickness forming panel 2230 may respectively and integrally extend from the opposite widthwise ends of the first-side shielding panel 2280A. The second-side shielding panel 2280B, which shields the second-side open portion in the longitudinal direction of the cavity C, may be divided into two sections (i.e., the first second-side shielding panel 2280B-1 and the second second-side shielding panel 2280B-2 in FIG. 17) and integrally formed on the first-side thickness forming panel 2220 and the second-side thickness forming panel 2230, respectively.

On an outer end of one of the second-side shielding panels 2280B (which corresponds to the first second-side shielding panel 2280B-1 in the third embodiment 2200 of the present disclosure), the partition panel 2290 may be integrally formed to divide the cavity C into two first-and second-side spaces in the width direction and have at least one window 2291 or 2292 cut out.

In the filter 2200 for communication devices according to the third embodiment of the present disclosure, a folding method and sequence of the base plate 2205 also follow those referenced in FIG. 17.

Thus far, the filters 100, 2100, and 2200 for communication devices according to the embodiments of the present disclosure have been described in detail with reference to the accompanying drawings. However, embodiments of the present disclosure are not limited to the foregoing embodiments, and it is apparent to those skilled in the art that various changes may be made thereto without departing from the claims and equivalents thereof. Accordingly, the true scope of the present disclosure should be defined by the appended claims.

### INDUSTRIAL APPLICABILITY

The present disclosure provides a filter for communication devices that can eliminate conventional joining processes for forming a cavity and providing structures such as resonators within the cavity, thereby reducing insertion loss caused by coupling of two physical structures.

1. A filter for communication devices, comprising: a base plate made of a conductive material, and manufactured in an unfolded state, the base plate being configured to be foldable such that, upon folding, a cavity is formed inside while simultaneously positioning a plurality of resonators to protrude by a set length in a thickness direction or a width direction in the cavity,
wherein the plurality of resonators each include, at a distal end portion thereof, a resonance characteristic end that integrally connects leading ends of a pair of remaining portions extending in a thickness direction in the cavity.

2. The filter of claim 1,
wherein at least one of the plurality of resonators is connected with an input terminal pin that is provided as a separate element and connected to an input port of a main board so that a signal transmitted from the input port is received, and
wherein at least one other of the plurality of resonators is connected with an output terminal pin that is provided as a separate element and connected to an output port of the main board so that a signal is transmitted to the output port and then output.

3. The filter of claim 1, wherein the plurality of resonators each comprise:
a pair of resonance bars corresponding to the pair of remaining portions; and
the resonance characteristic end connecting the leading ends of the pair of resonance bars, and
wherein the pair of resonance bars are formed such that the respective leading ends thereof become increasingly spaced apart in the thickness direction of the cavity.

4. The filter of claim 1, wherein the plurality of resonators each comprise:
a pair of resonance bars corresponding to the pair of remaining portions; and
the resonance characteristic end connecting the leading ends of the pair of resonance bars, and
wherein the pair of resonance bars are formed such that the respective leading ends thereof are spaced apart in parallel in the thickness direction of the cavity.

5. The filter of claim 1, wherein the plurality of resonators each comprise:
a pair of resonance bars corresponding to the pair of remaining portions; and
the resonance characteristic end connecting the leading ends of the pair of resonance bars, and
wherein the resonance characteristic end of each of the plurality of resonators is formed with a width equal to or greater than a width of the leading ends of at least the pair of resonance bars.

6. The filter of claim 1, wherein the plurality of resonators each comprise:
a pair of resonance bars corresponding to the pair of remaining portions; and
the resonance characteristic end connecting the leading ends of the pair of resonance bars, and
wherein the pair of resonance bars are each formed such that a base portion thereof corresponding to a bottom surface of the cavity and the leading end thereof have a largest width, while an intermediate portion thereof has a smallest width.

7. The filter of claim 1,
wherein the base plate is made of either a conductive material or a non-conductive material, and
wherein in case that the base plate is made of the non-conductive material, a conductive material is formed as a coating layer by plating at least on an interior corresponding to the cavity.

8. The filter of claim 1, wherein the cavity is filled with air having a dielectric constant of 1.

9. The filter of claim 1, wherein the base plate, after folding, comprises:
a body bottom forming panel that forms a bottom surface of the cavity;
a first-side thickness forming panel and a second-side thickness forming panel that increase a size of the cavity in the thickness direction; and
a body top forming panel provided in a shape covering a top of the cavity.

10. The filter of claim 9, wherein the body bottom forming panel comprises:
a first-side body bottom forming panel that forms a first-side bottom surface of the cavity; and
a second-side body bottom forming panel that forms a second-side bottom surface of the cavity, and
wherein the first-side body bottom forming panel and the second-side body bottom forming panel form a complete bottom surface of the cavity after folding, except for areas where the resonators are formed.

11. The filter of claim 9, wherein the base plate, after folding, further comprises a first-side shielding panel and a second-side shielding panel that shield a first longitudinal end and a second longitudinal end of the cavity.

12. The filter of claim 10, wherein the plurality of resonators are formed on the first-side body bottom forming panel and the second-side body bottom forming panel.
